(19) United States
(12) Patent Application Publication
(10) Pub. No.: US 2003/0101061 A1
(43) Pub. Date: May 29, 2003

(54) Securing prospective representatives for a home based business

(76) Inventor: Shawn M. Wheeland, Aiken, SC (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/870,892

(22) Filed: May 31, 2001

(51) Int. Cl. G06F 17/60

(52) U.S. Cl. 705/1

(57) ABSTRACT

Systems and methods for securing leads or prospects. Through a web site of an owner, a visual presentation is shown to a prospect that causes the prospect to experience wistful regret. The prospect is then provided with facts through the visual presentation that enables the prospect to have hope as representatives of the owner and/or through their own home based business. If the prospect has sufficient interest, an online interview is given, which requires the prospect to provide more than just contact information to an owner. The results of the online interview are provided to the owner through an email and the owner then conducts a personal interview with the prospect. Finally, the successful prospect becomes both a representative of the owner and receives their own copy of the owner's web site for use in their own home based business.

### BACKGROUND OF THE INVENTION

1. The Field of the Invention

The present invention relates to systems, methods, and computer program products for securing prospective representatives for a home based business. More particularly, the present invention relates to systems, methods, and computer program products that provide owners of home based businesses with leads to prospective representatives that are interested in a business of the owner.

2. Background and Related Art

Home based businesses often face many of the same challenges that are faced by other types of businesses. One challenge, of course, is to sell as much product as possible, whether the product is a service or a good and another challenge is to effectively and efficiently distribute the product. With home based businesses, product distribution is often achieved through representatives of the home based business. These challenges are related in that having more representatives typically translates to selling more product. Unfortunately, owners of home based businesses often find it difficult to find and secure representatives for their home based businesses.

Even though the challenges faced by home based businesses and retail businesses are similar, the approach taken to overcome these challenges can be significantly different. Retail businesses, for example, often rely on mass media (newspapers, magazines, television, and radio) to advertise their product as well as to find and secure additional representatives or employees. In contrast, a home based business often finds that mass media is prohibitively expensive. As a result, home based businesses have found other solutions to these challenges of selling product and increasing product distribution.

Because the amount of product sold is sometimes related to the number of representatives that are selling the product, home based businesses have often focused on increasing the number of their representatives. Some of the primary methods used for finding and securing prospective representatives are through personal contact, which includes one on one meetings, home based meetings, business parties, and the like. In each case, the prospective representative is usually given the opportunity to both purchase product as well as become a representative of the owner. The prospective representative is sometimes given the opportunity to have their own home based business.

The difficulty in increasing the number of their representatives through personal contact is often related to the interest of the potential or prospective representatives. Sometimes, prospective representative initially demonstrate a high level of interest. Unfortunately, the interest of the prospective representative is short lived and an owner of a home based business thus spends significant time interacting with prospective representatives that have no interest in either purchasing product or becoming a representative of the home based business even though, in many instances, the representatives are given the opportunity to become owners of their own home based business.

Another method for finding prospective representatives is through the use of telephone and mail solicitations. Using the telephone and mail systems to sell product and find prospective representatives is even more difficult than through personal contact primarily because these are cold contacts to persons that usually have no interest in the business of the owner. Along a similar vein, electronic messaging can be used by distributing mass electronic mailings to prospective representatives, but the interest of the email recipients is often unknown and cannot be measured. The cost of using these systems is usually quite expensive based on the number of leads to interested prospective representatives that they produce for the owner. In addition, it is usually necessary for the home based business owner to procure a list of telephone numbers, addresses, and/or email addresses, which can incur significant cost to the business owner.

In some cases, the Internet has been used to find prospective representatives for the owner of a home based business. In these cases, however, the prospective representative simply fills out a form providing basic information such as name, address, and telephone number through which the prospective representative may be contacted. Even in this case, the interest level of the prospective representative is unknown and unmeasured and the home based business owner is thus required to spend time with uninterested and potentially unqualified prospective representatives.

Even though these methods of securing prospective representatives are successful to a small degree, the task of finding and securing prospective representatives is a difficult task that consumes the time and resources of the business owner because the business owner is still spending their time and resources with many prospective representatives who either do not have sufficient interest in becoming a representative or who are not qualified to become a representative of the owner.

### SUMMARY OF THE INVENTION

These and other problems are overcome by the present invention, which relates to systems, methods, and computer program products for securing prospective representatives that have sufficient interest in becoming a representative of the owner's home based business. In addition to finding and securing prospective representatives, the qualifications of the prospective representatives are also measured or determined in accordance with the present invention.

One component of the present invention is a self replicating web site that belongs to the business owner. When a prospective representative accesses the business owner's web site, the prospective representative is shown a visual presentation that causes the prospective representatives to reflect over the choices that they have made in their lives. In one example, the visual experience is presented as a flash video or as streaming video. The feelings induced in the prospective representatives by the visual presentation are often referred to as wistful regret which, in some instances, is related to the time that the prospective representatives could have spent with their children or to lost opportunities.

After causing the prospective representatives to reflect over the choices they have made or experience wistful regret, the visual presentation continues by presenting factual information often relating to employment and income. The visual presentation culminates by providing the prospective representative with hope by illustrating the potential of using the Internet and electronic commerce in their own home based business or as representatives of an owner. After the visual presentation has terminated, the user cannot proceed unless they demonstrate an adequate level of commitment and show sufficient interest in pursuing the opportunity that is being presented to them through the visual presentation. If the user or prospective demonstrates sufficient interest, the proceed to an online interview. If the prospective representative does not demonstrate sufficient interest, the prospective representative is encouraged to return at a later time when they have more interest in becoming a representative.

The prospective representative that demonstrates sufficient interest is given an online interview. The online interview does not simply collect generic information about the prospective representative. Instead, the online interview asks probing questions that are intended to aid the owner of the web site in determining whether the prospective representative has sufficient interest and/or is qualified. The results of the online interview are sent to the owner of the web site, who then conducts a personal interview with the prospective representative. The personal interview can be conducted in several ways, but is most often conducted by telephone. An advantage of the present invention is that interested prospective representatives are found before they interact with the owner. Thus web site owners are spending their time and resources with interested prospective representatives.

Because the business owner spends time talking with interested persons instead of talking with persons whose interest is unknown, the business owner has a better chance of successfully securing the prospective representative as a representative. The visual presentation and the following interviews allow the owner to determine why the prospective representative is looking for an opportunity and to determine how the business owner can help the prospective representative succeed in their own home based business. Another feature of the present invention is that the successful prospects are provided with their own copy of the self replicating web site to enable them to successfully find and secure their own representatives. In essence, the representative becomes a home business owner who finds and secures their own representatives.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram illustrating relationships between business owners, representatives and prospective representatives;

FIG. 3 is a diagram illustrating an exemplary system and method that allows a business owner to secure a lead or a prospective representative; and

FIG. 4 is a block diagram illustrating a self-replicating website and the relationships of the website to owners, representatives, and prospective representatives.

### DETAILED DESCRIPTION OF THE INVENTION

Persons or other entities that may become representatives of an owner's home based business as well as an owner of their own home based business are referred to herein as “prospects” or “prospective representatives.” Securing prospective representatives or prospects for home based businesses is often difficult because the interest and qualifications of the prospects cannot be determined without an investment of time and money and the success or failure of home based businesses often depends on the ability of the owner of the home based business to recruit and secure new prospects. The number of prospects that actually become representatives of the owner often corresponds with an increase in the distribution of the owner's product. In many instances, the owner's representatives are also able to establish themselves as owners of their own home based business. Of course, they are then faced with the problem of finding prospects that can become representatives, which will in turn allow their home based business to increase and expand.

As previously described, one element of obtaining new representatives is related to the interest level and qualifications of prospects or prospective representatives. The present invention is used by an owner to develop their home based business by helping them find and secure prospects that are interested and qualified. According to one embodiment of the present invention, a replicating web site is used to find these leads or prospects for the owner. The web site interacts with prospects in a manner that causes the prospects to reflect on the choices and decisions that they have made in their life. The web site next engenders hope in the prospects for the future and requires that they make a commitment to investigate the opportunity presented through the web site before they are allowed to proceed. Only those prospects that demonstrate sufficient interest are allowed to explore the opportunity presented through the web site. Thus, the interest of the prospect can be determined without an investment of time and money by the owner for each prospect.

If the prospects are sufficiently interested, they are given an online interview that is used as a basis by the owner of the web site for a personal interview. Successful prospects become representatives of the owner. Each prospect may also become an owner of their own home based business as well.

The web site is effectively a tool of the home based business owner to find interested and qualified prospects. Successful prospects are also given the opportunity to procure a duplicate of the web site of the owner, which allows them to find and secure their own leads or prospects. The owner is thus relieved of the resource consuming tasks of interacting with prospects that do not have either the interest in participating in the business opportunity and/or the necessary qualifications.

While the present invention is described with respect to home based businesses, the systems and methods taught herein are not strictly limited to home based businesses, but can be applied in other situations such as retail businesses, enrollment, and the like for other purposes. For example, retail businesses can implement the systems and methods described herein to secure additional customers instead of representatives. Businesses, colleges and the like can use the systems and methods described herein to bolster enrollment.

The present invention extends to both methods and systems for securing prospective representatives for a home based business. The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

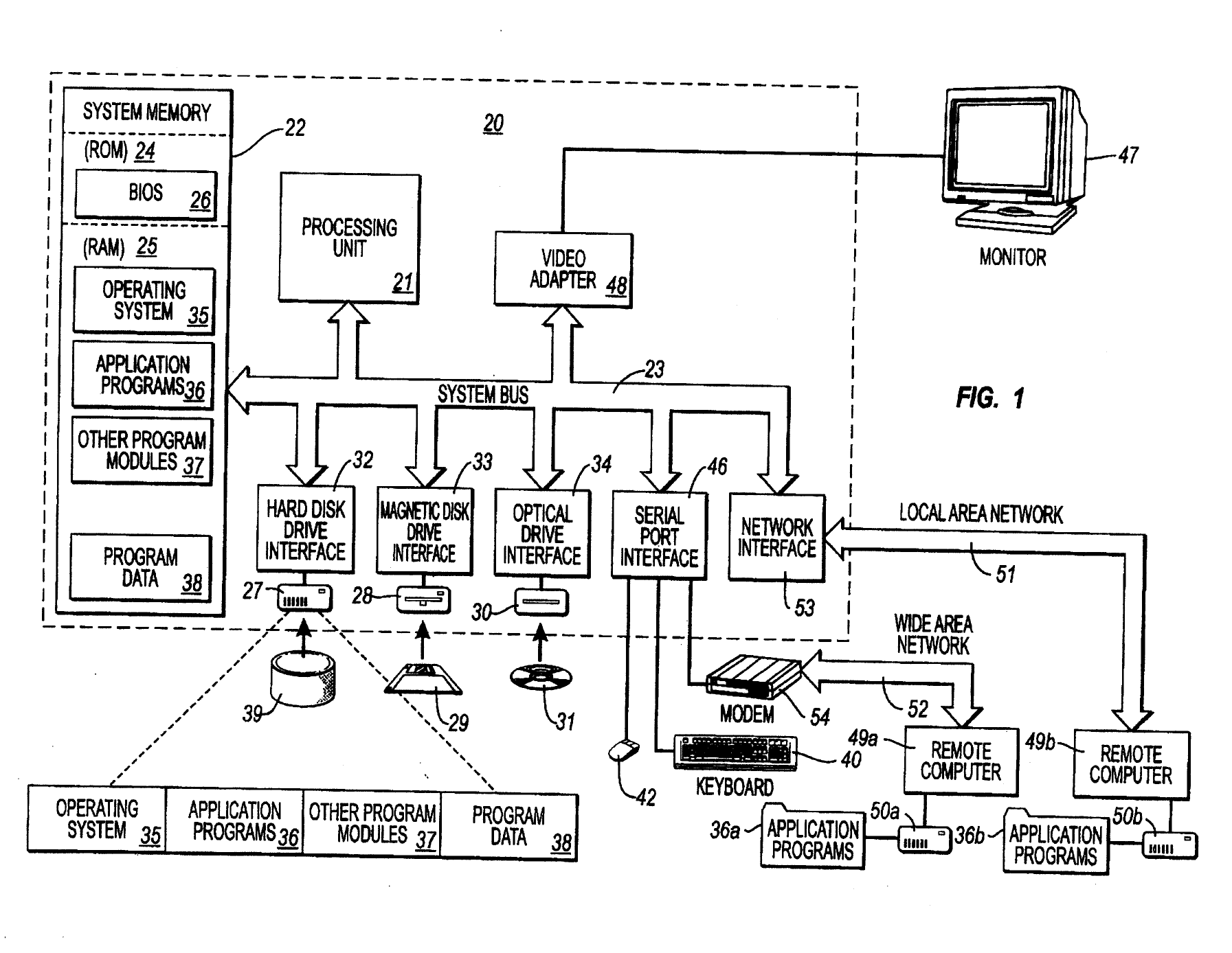

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface coupled to system bus 23. Alternatively, the input devices may be connected by other interfaces, such as a parallel port, a game port or a universal serial bus (USB). A monitor or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

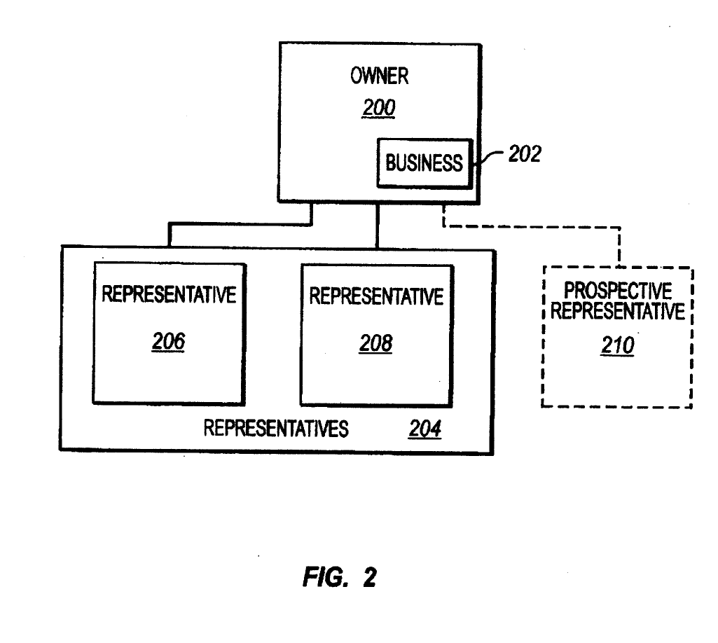

FIG. 2 illustrates an exemplary environment in which the systems and methods of the present invention may be implemented. FIG. 2 illustrates an owner 200 who has a home based business 202. One goal of the owner 200 is to increase revenue or income, which is sometimes achieved by selling more product and/or increasing the number of representatives 204, who also sell the product either on behalf of the owner 200 and/or for themselves.

In this example, the owner 200 has a representative 206 and a representative 208. In order to increase the number of representatives, the owner 200 needs to secure a prospective representative 210, who is committed and qualified to participate in the business 202 of the owner 200. As previously described, an owner often spends significant time and resources interacting with prospective representatives that are uninterested in the business 202 or are not qualified to participate in the business 202. The owner 200 preferably desires to have leads to interested and/or qualified prospects, which would result in the owner 200 spending time with prospects that are more likely to become representatives of the business 202 and/or owners of their own home based business.

FIG. 2 can be adapted to other situations as well. For example, the owner 200 could be a college that is seeking to increase enrollment. The representatives 204 are current students and the prospective representative 210 corresponds to prospective students.

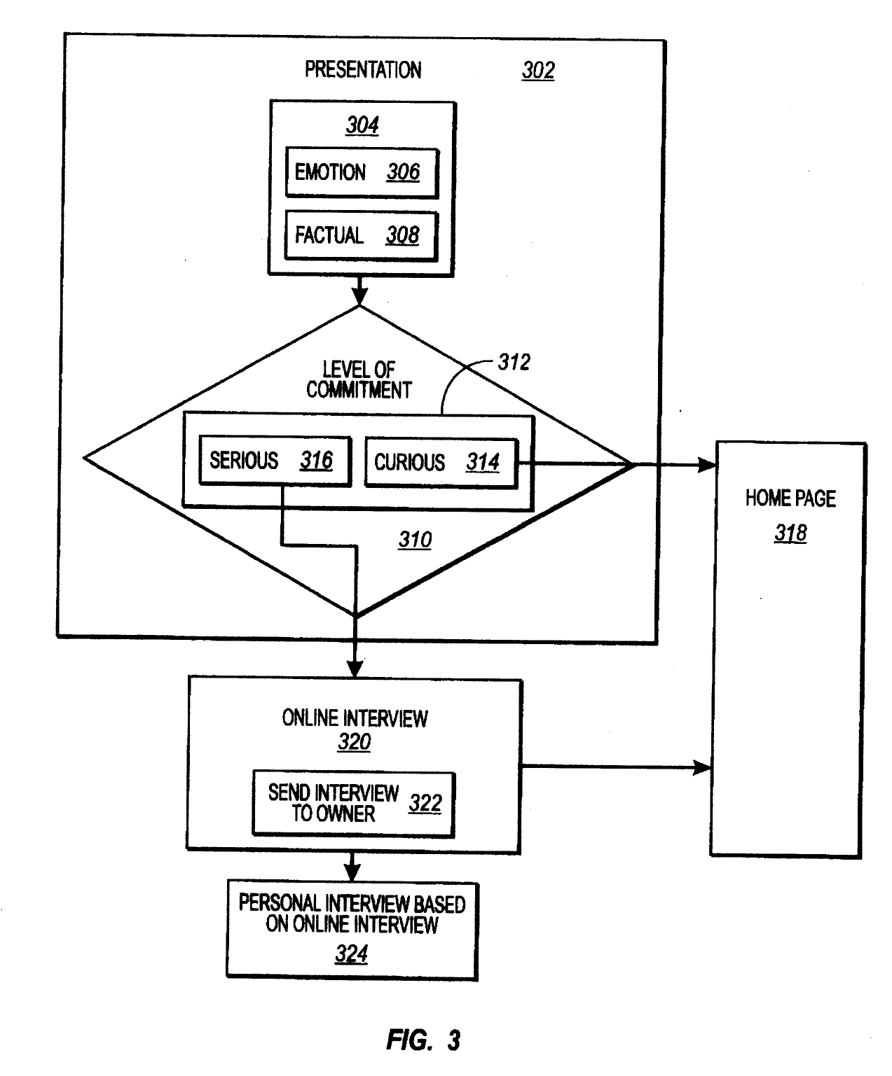

FIG. 3 is a flow diagram illustrating an exemplary process that provides the owner 200 of FIG. 2 with leads to interested prospective representatives without the owner spending time and/or resources with uninterested prospective representatives. FIG. 3 begins with a presentation 302 that is usually offered or presented, for example, on a web site that is accessed over a network such as the Internet. In this example, the presentation 302 is a web page or site that includes a visual presentation 304 that often includes audio. A reference to the visual presentation 304 inherently includes the audio. The visual presentation 304 can be accomplished using, for example, flash technology, video streaming, and the like. The web site can be accessed by the prospective representative and the presentation is able to identify those prospective representatives that have a desired level of commitment or interest in becoming a representative of the owner's home based business as is described in more detail below. The web site operates independently of the owner and frees the owner to pursue other activities while the interested prospected representatives are ultimately referred to the owner of the web site.

The visual presentation 304 has an emotion portion 306 and a factual portion 308. The visual presentation 304 usually begins with the emotion portion 306, which evokes wistful regret in the prospective representative that is viewing the visual presentation. The emotion portion 306 may cause the prospective representative to account to themselves for their lives by reminding them of the decisions that they may have made whose consequences have been unsatisfactory. For example, the emotion portion 306 may remind the prospective representative of broken promises that they have made to their children, or the emotion portion 306 may remind the prospective representative that they have not spent enough time with family members, or the emotion portion 306 may remind the prospective representative that they have not realized their income potential or that their choice of employment has limited possibilities.

The next portion of the visual presentation 304 is the factual portion 308. The factual portion 308 provides data indicating conditions, including financial conditions, of people, businesses and the like. For example, the factual portion 308 may indicate the average income of certain groups of persons, or the factual portion 308 may present a percentage of families that have two working parents. The factual portion 308 may also include information relating to Internet usage such as the fact that thousands of persons are accessing the Internet for the first time on a daily basis. Finally, the factual portion 308 of the visual presentation 304 inspires hope in the prospective representative that the effects of their prior decisions can be overcome and that their lives can be changed by the opportunity that is being presented to them.

The visual presentation 304 is adaptable to the business of the owner. The visual presentation 304, for example, can be customized to various industries including, but not limited to, nutrition, telecommunications, and e-commerce. In each case, the factual portion 308 of the visual presentation 304 is related to the business of the owner while the emotion portion 306 is usually the same for each industry.

Next, the prospective representative is given the opportunity to commit (310) and demonstrate their interest in becoming a representative and/or a home based business owner. In this example, the prospective representative is presented with a curious button 314 and a serious button 316 through the user interface 312. If the prospective representative chooses the curious button 314, then the prospective representative is directed to a home page 318 that provides general information about the web site and invites the prospective representative to return at a later time when their interest in becoming a representative is more serious.

If the prospective representative selects the serious button 316, it is an indication that the prospective representative has sufficient interest in pursuing this opportunity to become a representative of and owner and/or a home based business owner. One advantage of having prospective representatives commit (310) or demonstrate sufficient interest is that the owner of the business does not have to spend time interacting with an uninterested prospect, but can use their time more productively with interested prospects.

After the prospective representative has demonstrated some interest and selected the serious button 316, an online interview 320 is given to the prospective representative. The online interview 320 is designed to help the owner of the web site and of the home based business learn valuable information about the prospective representative. This is useful because successful prospecting is usually achieved when the prospective representative's motives for seeking a new opportunity are known to the owner.

The online interview 320 typically begins by obtaining personal information from the prospective representative such as name, address, email address, telephone number, and the like. The online interview, however, is not limited to simply collecting contact information because contact information does not provide the owner with insight into the prospective representative. In this example, the online interview 320 continues by asking other probing questions of the prospective representative that allow a reviewer or owner to determine certain aspects of the prospective representative's life. The online interview 320 is used by the owner to determine whether or not to continue to pursue the prospective representative.

The following questions are examples of questions that may be presented to a prospective representative in the online interview 320. These questions are not exhaustive of the questions that may be asked in the online interview and it is not a requirement that all of these questions be asked to the prospective representative in the online interview 320. The exemplary questions include:

What would you do with an extra $500 each month?

What about you makes you feel qualified for our program?

What did you do to earn money as a child?

Have you ever owned your own business? If so, what type of business?

If this turned out to be the program you've been looking for, would there be anything to stop you from getting started right away?

How would working at home benefit you?

How would it feel to be able to fire your boss?

Do you believe you could earn a six figure income? and

What is the best time of day to reach you?

These types of questions enable an owner to better understand the problems that the prospective representatives are trying to solve. The owner can also glean an understanding of the prospective representative's work ethic and background. After the online interview 320 has been completed by the prospective representative, the results of the online interview are placed in an email that is sent to the owner (322). Alternatively, the results can be automatically sent to the owner in other ways, including by facsimile or by regular mail.

After the online interview 320, the prospective representative is directed to the home page 318. The home page 318 provides additional information about the web site and/or the business of the owner to the prospective representative. From the home page 318, the prospective representative can browse the site and explore the information presented on the home page 318. In the meantime, the results of the online interview 320 have been sent to the owner of the website.

After the owner has reviewed the results of the online interview 320, the owner is able to initiate a personal interview 324 by, for example, telephone or in person. During the personal interview 324, the owner is able to expand on the information provided by the prospective representative in the online interview 320. In determining whether a prospective representative has sufficient interest and/or is qualified, some of the questions may have more weight and importance than other questions. The owner is able to determine this from the information submitted in the online interview 320 and from the personal interview 324. The personal interview 324 is also a training opportunity that allows the owner to teach the prospective representative how to use the web site as well as run their own home based business.

One advantage of the present invention is that the owner is able to talk to interested prospects during the personal interview. If the online interview, for example, indicates that the prospect is not motivated and is not willing to work hard, then they are simply disqualified and the personal interview 324 may be brief or not conducted. On the other hand, the personal interview 324 allows the owner to ask more deeply probing questions to those prospects that have shown interest and/or that appear qualified. Those prospects that successfully finish the personal interview 324 can become representatives of the owner as well as owners of their own home based business.

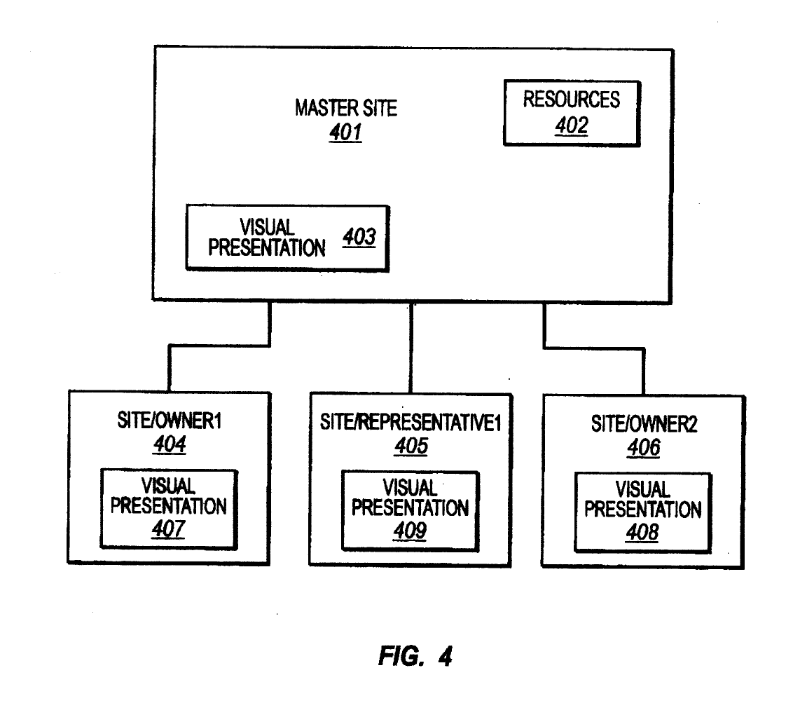

FIG. 4 is a block diagram that illustrates exemplary web sites that are employed by the owners of home based businesses to find and secure new leads or prospects. Site 401 is a master web site that contains the master versions of the visual presentations that are viewed by the prospective representatives on the owners web sites. Thus, the visual presentation 403 includes customized versions of the visual presentation including versions of the visual presentation, as previously mentioned, for e-commerce, telecommunications, and nutrition. The master site 401 also includes resources 402, which includes audio files, financial calculators, and the like for those owners who use or subscribe to the master site 401. The resources 402 also includes statistics about the web sites of the owners that may be accessed by the individual owners.

When an owner chooses to use or subscribe to the site 401, the owner usually pays a subscription fee. In return, the owner receives a copy or replica of the site 401 that is tailored to the home based business of the owner. The replicas are usually hosted by the master site 401 The web site of the owner1, shown as site/owner1 404, has a visual presentation 407 that is tailored to the home based business of the owner1. The web site of the owner2, shown as site/owner2 406, is similar to the site/owner1 404 except that the visual presentation 408 is tailored to the home based business of the owner2. The owner2 also pays a subscription fee to the site 401. The subscription fee is usually periodic such as monthly.

When an owner is securing prospects or prospective representatives, the owner1, for example, may refer a prospect to the site/owner1 404. If the prospect becomes a representative through the site/owner1 404, then the representative may desire to receive their own web site, shown as site/representative1 409, which is a copy of the master site 401 or of the site/owner1 404. Typically, the visual presentation 409 of the site/representative1 405 is identical to the visual presentation 407 of the site/owner1 404 because the representative1 was secured by the owner 1 and they are engaged in the same home based business. The representative thus becomes an owner of their own site (site/representative1 409) for use in their own home based business. The representative can also use the site to secure additional representatives for other owners.

Often, the representative acknowledges that an owner referred the representative to the owner's site/owner1 404 or to the master site 401. In this case, the referring owner receives a rebate amount for each referred representative that procures a subscription to the master site 401. The representative can also receive a rebate for each prospective representative that subscribes to the service through the site/representative1 405 of the representative.

The master site 401 is replicated for each new owner or representative and is customized according to the business of the new owner, who may be a representative of another owner. The replicated web site is used as a tool or system to find and secure prospects for the businesses of the owners. In this manner, the number of representatives of a home based business is increased.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system including an owner having a business, wherein the owner has representatives for the business and wherein the owner spends time and resources attempting to secure prospective representatives that are not interested in the business of the owner, a method for securing an interested prospective representative for the business of the owner, the method comprising acts of:
presenting a visual presentation to the prospective representative on a web site of the owner;
determining that the prospective representative has interest in becoming a representative of the business such that the owner is able to interact with the interested prospective representative;
performing an online interview with the prospective representative; and
submitting results of the online interview with the prospective representative to the owner.

2. A method as defined in claim 1, wherein the act of presenting a visual presentation further comprises an act of the prospective representative accessing a web site of the owner, wherein the visual presentation is stored on the web site of the owner.

3. A method as defined in claim 1, wherein the act of presenting a visual presentation further comprises an act of evoking wistful regret in the prospective representative through an emotion portion of the visual presentation.

4. A method as defined in claim 3, wherein the act of presenting a visual presentation further comprises an act of providing factual data to the prospective representative through a factual portion of the visual presentation, wherein the factual data is provided after the emotion portion.

5. A method as defined in claim 1, wherein the act of determining that the prospective representative has interest further comprises an act of requiring the prospective representative to commit to the online interview.

6. A method as defined in claim 1, wherein the act of determining that the prospective representative has interest further comprises an act of inviting the prospective representative to return at a later date when the prospective representative does not have sufficient interest.

7. A method as defined in claim 1, further comprising an act of the owner conducting a personal interview with the prospective representative based on the results of the online interview.

8. A method as defined in claim 7, wherein the act of conducting a personal interview further comprises an act of the owner expanding on the results of the online interview during the personal interview.

9. A method as defined in claim 8, wherein the personal interview is conducted over a telephone.

10. In a system including an owner having a home based business, wherein the owner seeks representatives for the home based business, a method for securing leads to prospective representatives for the owner, the method comprising acts of:
showing a visual presentation to the prospective representative at a web site of the owner, wherein the visual presentation includes an emotion portion and a factual portion;
committing the prospective representative to an online interview at the conclusion of the visual presentation, wherein the commitment evinces sufficient interest of the prospective representative;
performing an online interview with the prospective representative if the prospective representative commits to the online interview; and
sending results of the online interview to the owner of the web site.

11. A method as defined in claim 10, further comprising an act of directing the prospective representative to the web site of the owner.

12. A method as defined in claim 10, wherein a successful prospective representative receives a replica of a master web site that is essentially identical to the web site of the owner.

13. A method as defined in claim 10, wherein the act of showing a visual presentation further comprises an act of evoking wistful regret in the prospective representative.

14. A method as defined in claim 10, wherein the act of showing a visual presentation further comprises an act of providing hope to the prospective representative through the factual portion of the visual presentation.

15. A method as defined in claim 10, wherein the visual representation is directed to an industry, wherein the industry is one of telecommunications, nutrition, and e-commerce.

16. A method as defined in claim 10, wherein the act of committing the prospective representative to an online interview further comprises an act of requiring the prospective representative to demonstrate sufficient interest.

17. A method as defined in claim 16, wherein sufficient interest is demonstrated by the prospective representative selecting a serious button on the web site and insufficient interest in demonstrated by the prospective representative selecting a curious button on the web site, wherein the serious button and the curious button are provided to the prospective representative after the visual presentation.

18. A method as defined in claim 10, further comprising an act of the owner conducting a personal interview with the prospective representative, wherein the personal interview is based on results of the online interview, wherein a successful prospective representative becomes a representative of the owner.

19. A method as defined in claim 18, wherein the personal interview is conducted over a telephone.

20. A computer program product having computer executable instructions for performing the acts recited in claim 10.

21. A system for use by an owner in securing prospects such that the owner spends time with interested prospects, the system comprising:
a master web site, the master web site including a master presentation;
one or more replica web sites, wherein each replica web site has an owner and wherein each owner subscribes to the master web site, each replica web site comprising:
a customized version of the master presentation;
a commitment component for determining an interest of the prospects of the owner; and
an online interview component for those prospects that demonstrate sufficient interest, wherein results of the online interview are sent to the owner; and
a personal interview component for conducting a personal interview with prospects that demonstrate sufficient interest, wherein the personal interview is based on the results of the online interview.

22. A system as defined in claim 21, wherein the master presentation includes customized versions of a visual presentation.

23. A system as defined in claim 22, wherein the customized versions include:
a telecommunications version of the visual presentation;
a nutrition version of the visual presentation; and
an electronic commerce of the visual presentation.

24. A system as defined in claim 22, wherein the master web site further comprises resources for use by owners of the replica web sites.

25. A system as defined in claim 24, wherein the resources include audio files and statistics.

26. A system as defined in claim 22, wherein the customized version of the master presentation comprises an emotion portion for evoking wistful regret in the prospects and a factual portion to provide hope to the prospects.

27. A system as defined in claim 22, wherein the personal interview component occurs over a telephone.

28. A system as defined in claim 22, wherein successful prospects receive a new replica of the master web site, including a visual presentation substantially identical to a visual presentation of the replica web site of the owner.
